(19) United States
(12) Patent Application Publication
(10) Pub. No.: US 2013/0297927 A1
(43) Pub. Date: Nov. 7, 2013

(54) ELECTRONIC DEVICE AND METHOD FOR MANAGING AN ELECTRONIC DEVICE SETTING THEREOF

(71) Applicant: SAMSUNG ELECTRONICS CO., LTD., Suwon-si (KR)

(72) Inventor: Revoti Prasad BORA, Noida (IN)

(73) Assignee: SAMSUNG ELECTRONICS CO., LTD., Suwon-si (KR)

(21) Appl. No.: 13/888,766

(22) Filed: May 7, 2013

(30) Foreign Application Priority Data
May 7, 2012 (IN) 1751/CHE/2012
Apr. 5, 2013 (KR) 10-2013-0037699

(51) Int. Cl. G06F 9/44

(52) U.S. Cl. CPC G06F 9/4421
USPC 713/100

(57) ABSTRACT

An electronic device and a method for managing an electronic device setting are provided. When a predetermined user command is inputted, the electronic device determines user information of a user of the electronic device, identifies user information of a plurality of users from plurality of sources, compares the user information of the user of the electronic device and the user information of the plurality of users, and determines at least one user who has a high similarity level to the user of the electronic device among the plurality of users based on a comparison result, receives an electronic device setting from at least one user who has a high similarity level, and displays an electronic device setting which was received from a user who has a highest similarity level among the received electronic device settings.

### CROSS-REFERENCE TO RELATED APPLICATIONS

This application claims priority from Indian Patent Application No. 1751/CHE/2012, filed in the Indian Patent Office on May 7, 2012, and Korean Patent Application No. 10-2013-0037699, filed in the Korean Intellectual Property Office on Apr. 5, 2013, the disclosures of which are incorporated herein by reference.

### BACKGROUND

1. Field

Methods and apparatuses consistent with the exemplary embodiments relate to an electronic device and a method for managing an electronic device setting thereof, and more particularly, to an electronic device which manages and executes a plurality of applications and a method for managing an electronic device setting thereof.

2.Description of the Related Art

Recently, electronic devices, for example, televisions, computers, laptops, mobile phones, handheld devices and telecommunication devices have become increasingly popular as the electronic devices are enabled with multiple applications. Further, the electronic devices are also enabled with touch functionalities for providing input by a user. Due to the presence of the multiple applications embedded in the electronic device, device management becomes important. The device management includes providing device configurations, for example, but not limited to, displaying specific icons, creating shortcuts for one or more software programs, providing one or more configuration settings, providing one or more user interface settings, taskbars, menu bars and the like. The electronic device should be configured such that a sub set of applications required by the user are readily available in contrast to the user manually selecting the applications that are required at a particular instant of time. The device management enables the user to readily access or execute the required applications.

Related art techniques aim to provide the device configuration based on a context of the user, user profile, and frequency of use. The context of the user is determined using one or more means, for example, a Global Positioning System (GPS) is used for determining a location of the user. Further, the sub set of applications, for example, icons for accessing one or more software applications, web pages, toolbars and the like, are readily provided to the user based on the determined context. Further, the sub set of applications are also provided based on the frequency of use of the applications. In one example, if the MS word application is frequently used, then the technique is configured to create and further provide a shortcut path for instantly enabling the MS word application when the user uses the electronic device. Furthermore, the user profile is used to maintain one or more preferences of the user. The preferences can be referred to as preferred applications, and are executed by the user at various contexts. The sub set of applications for readily accessing the one or more software applications, the web pages, the toolbars and the like is provided based on the one or more preferences of the user. However, the technique requires further manual configurations, since the device configuration that are provided based only on context and frequency of use is not accurate. Hence, the user has to spend some time to perform manual settings to obtain required device configurations.

In the light of the foregoing discussion there is a need for a system and a method for providing enhanced device management configurations based on a distributed user experience.

### SUMMARY

An aspect of the exemplary embodiments relates to a method for managing an electronic device setting which enables a user to access and execute various applications more easily without manually performing an environment setting, and an electronic device to which the method is applied.

In accordance with an exemplary embodiment, a method for managing an electronic device setting of an electronic device includes, when a predetermined user command is inputted, determining user information of a user of the electronic device; identifying user information of a plurality of users from a plurality of sources through a network; comparing the user information of the user of the electronic device and the user information of the plurality of users, and determining at least one user who has a high similarity level to the user of the electronic device among the plurality of users based on a comparison result; receiving an electronic device setting from the at least one user who has the high similarity level; and displaying an electronic device setting which is received from a user who has a highest similarity level among the received electronic device settings.

The user information may include at least one of a user context and user preference.

The determining may include determining a similarity level between a context and preference of the user of the electronic device and a context and preference of the plurality of users; setting a rank of the plurality of users based on the determined similarity level; and determining at least one user who holds a highest rank among the plurality of users.

The determining may include determining a user context by using at least one of a global positioning system (GPS) and an optical sensor.

The determining may include performing a security check for an electronic device setting of the at least one user who has the high similarity level; and when the security check is performed, applying the electronic device setting of the at least one user who has the high similarity level to the electronic device.

The electronic device setting may include at least one among a user interface setting, an electronic device environment setting, an application program setting, and an icon of at least one application software.

The electronic device setting may further include displaying user information of a plurality of users.

In accordance with an exemplary embodiment, an electronic device includes a communication device configured to perform communication with an external device; an input configured to receive a user command; a controller configured to determine user information of a user of the electronic device when a predetermined user command is inputted through the input, identify user information of a plurality of users from a plurality of sources through the communication device, compare the user information of the user of the electronic device and the user information of the plurality of users, and determine at least one user who has a high similarity level to the user of the electronic device among the plurality of users based on the comparison result, and control the communication device to receive an electronic device setting from the at least one user who has the high similarity level; and a display configured to display an electronic device setting which is received from a user who has the highest similarity level among the received electronic device settings.

In addition, the user information may include at least one of a user context and a user preference.

The controller may determine a similarity level between a context and preferences of a user of the electronic device and a context and preferences of the plurality of users, set a rank of the plurality of users based on the determined similarity level, and determine at least one user who holds a highest rank among the plurality of users.

The determining may include determining a user context by using at least one of a GPS and an optical sensor.

The controller may perform a security check for an electronic device setting of the at least one user who has the highest similarity level, and when the security check is performed, apply an electronic device setting of the at least one user who has the highest similarity level to the electronic device.

The electronic device setting may include at least one among a user interface setting, an electronic device environment setting, an application program setting, and an icon of at least one application software.

The display may display user information of a plurality of users.

### BRIEF DESCRIPTION OF THE DRAWINGS

FIG. 1 is a view illustrating a system which manages an electronic device setting based on user information in accordance with an exemplary embodiment;

FIG. 2 is a block diagram illustrating a configuration of an electronic device in accordance with an exemplary embodiment;

FIG. 3 is a block diagram illustrating a module which is included in an electronic device in accordance with an exemplary embodiment;

FIG. 4 is a flow chart which illustrates a method that an electronic device manages an electronic device setting based on user information in accordance with an exemplary embodiment; and

FIG. 5 is a flow chart which illustrates a method for managing an electronic device setting in accordance with another exemplary embodiment.

### DESCRIPTION OF EXEMPLARY EMBODIMENTS

It should be observed that the method steps and system components have been represented by related art symbols in the figure, showing only specific details which are relevant for an understanding of the exemplary embodiments. Further details may be readily apparent to persons of ordinary skill in the art, and may not have been disclosed. In the present disclosure, relational terms such as first and second, and the like, may be used to distinguish one entity from another entity, without necessarily implying any actual relationship or order between such entities.

Exemplary embodiments described herein provide a system and method of obtaining a device management configuration based on distributed user experience.

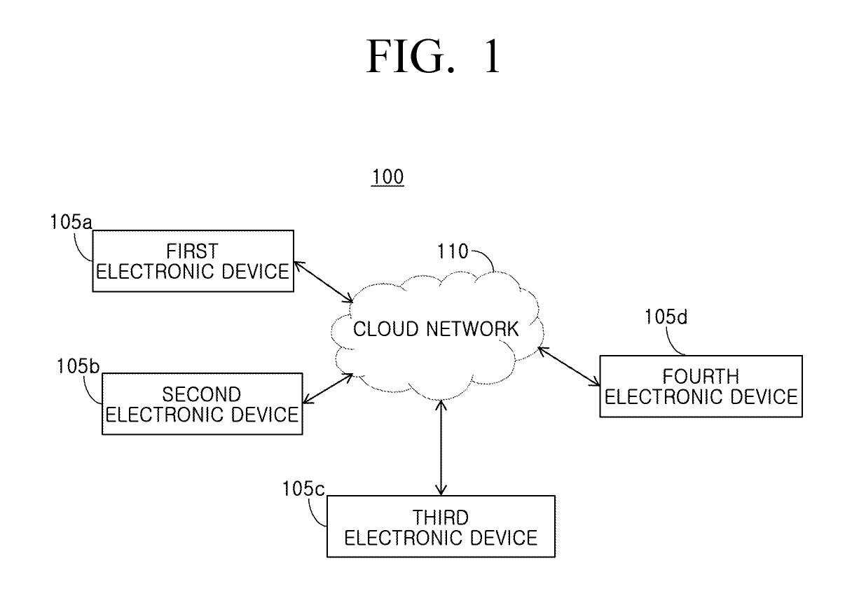

FIG. 1 is a block diagram of an environment 100 for obtaining a device management configuration based on distributed user experience, in accordance with an exemplary embodiment. The system 100 includes multiple electronic devices, for example, an electronic device 1 105a, an electronic device 2 105b, an electronic device 3 105c, an electronic device 4 105d. The system 100 also includes a cloud network 110. Examples of the electronic devices include, but are not limited to, computers, laptops, mobile phones, handheld devices personal digital assistants (PDA) and telecommunication devices. Examples of the cloud network 110 include, but are not limited to, local area network (LAN), wide area network (WAN) and wireless networks.

The electronic devices are operable to perform multiple applications. A user of an electronic device may use one application or a set of applications of the multiple applications frequently. Hence, device settings are required to be configured such that the application or the set of applications that are frequently used, by the user, are readily accessible to the user. Examples of the device settings include, but are not limited to, user interface settings, device configuration settings, application program settings and shortcuts for one or more application software. The device settings for the electronic device can be provided to the user based on a context of the user. Examples of the context include, but are not limited to, location, time, environment of the user, weather, part of the day and the like. Further, the device settings can also be provided to the user based on one or more preferences of the user. Examples of the preferences include, but are not limited to, using a particular software application during a specific part of the day and the like. The device settings can further be provided based on duration of using the one or more software applications or one or more user interface parameters by the user. In one example, the user may prefer to work upon one set of applications frequently at the office, and may prefer to use another set of applications frequently at home. Hence, the electronic device is configured to provide one device setting such that the set of applications can be instantly accessible by the user when the user is located at the office, and provide another device setting such that the set of applications can be instantly accessible by the user when the user is located at home. The electronic device is configured to alter the device settings based on, for example, but not limited to, the context of the user and the preference of the user.

In one exemplary embodiment, the device settings are provided to the user of the electronic device based on context associated with multiple users and one or more preferences associated with the multiple users. The multiple users may be derived from a network, for example, but not limited to, a social network or a professional network of the user of the electronic device through the cloud network 110. A set of users of the multiple users, with context and preferences similar to the user of the electronic device, are selected from the network of the user of the electronic device. Further, the set of users selected are ranked based on a similarity level of the context and the preferences. The similarity level indicates a degree of similarity existing between the context of the set of users and the context of the user of the electronic device. The similarity level indicates a degree of similarity existing between the preferences of the set of users and the preferences of the user of the electronic device. Upon a ranking process being performed, one or more users, from the set of users, holding the highest rank are selected. Further, device settings associated with the one or more users holding the highest rank is recommended to the user of the electronic device. The user of the electronic device can accept the recommended device settings to obtain one or more user interface parameters for executing one or more software applications instantly, thereby preventing manual configuration of the electronic device to obtain the required device settings.

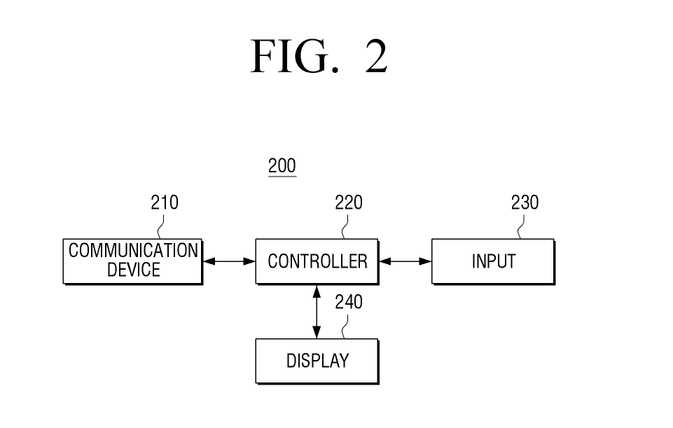

Hereinafter, referring to FIG. 2 and FIG, 3, an electronic device 200 which is manages an environment setting based on user information will be described.

FIG. 2 is a block diagram illustrating a configuration of an electronic device. As shown in FIG. 2, the electronic device 200 includes a communication device 210, a controller 220, an input 230, and a display 240.

The communication device 210 performs communication with an external device or a server through a network (e.g., a social network and a professional network, etc.) In this case, the communication device 210 may receive user information of a plurality of users from a plurality of sources (e.g., a user context and user preference.) In addition, the communication device 210 may receive an electronic device setting from at least one user who has a high similarity level to a user of the electronic device 200.

The communication device 210 may include various communication chips such as a WI-FI chip, a Bluetooth chip, a Near Field Communication (NFC) chip, and a wireless communication chip, etc. In this case, the Wi-Fi chip, the Bluetooth chip, and the NFC chip perform communication in a Wi-Fi method, in a Bluetooth method, and a NFC method, respectively. The NFC chip refers to a chip which operates in the NFC method using 13.56 MHz among various RF-ID frequency bands such as 135 kHz, 13.56 MHz, 433 MHz, 860-960 MHz, and 2.45 GHz. In case of using the Wi-Fi chip or the Bluetooth chip, various kinds of connection information such as SSID and a session key is transmitted and received. First, communication is established by using the connection information, and various kinds of information may be transmitted and received. The wireless communication chip refers to a chip which performs communication according to various communication standards such as IEEE, ZigBee, 3rd Generation (3G)), 3rd Generation Partnership Project (3GPP), and Long Term Evolution (LTE), etc.

The input 230 receives a user command for controlling the electronic device 200. Specially, the input 230 may receive a user command for receiving a recommendation of an electronic device setting from at least one user who has a high similarity level to a user of the electronic device 200.

The input 230 may be, but is not limited to, a touch screen, and may be embodied as various input devices such as a remote controller, a mouse, and a keyboard, etc.

The display 240 displays image data by a control of the controller 220. Particularly, the display 240 may display an electronic device setting which is received from a user who has a highest similarity level among a plurality of users received from a plurality of sources. In addition, the display 240 may display user information of the plurality of users received from the plurality of sources so that a user of the electronic device 200 is able to select user information.

The controller 220 controls overall operations of the electronic device 200 according to a user command which is inputted from the input 230. Specially, when a predetermined user command is inputted through the input 230, the controller 220 determines user information of a user of the electronic device 200. In this case, the predetermined user command may be a user command for activating a recommendation mode of an electronic device setting. User information may include at least one of a user context and a user preference. In this case, the controller 220 may determine a user context (e.g., location of a user, time, an environment of a user, weather, and a time zone, etc.) by using a plurality of sensors (e.g., an optical sensor, and a GPS, etc.)

The controller 220 may determine a user preference based on a user context. For example, when it is determined by a GPS that a user is located in an office, the controller 220 may determine an application which is preferred by the user while the user is located in the office. (e.g., MS-Word, etc.)

The controller 220 identifies user information of a plurality of users from a plurality of sources through the communication device 210. In this case, the controller 220 may obtain context information and preference information of a plurality of users.

The controller 220 compares user information of the electronic device 200 and user information of a plurality of users, and determines at least one user who has a high similarity level to a user of the electronic device among the plurality of users, based on a comparison result. To be specific, the controller 220 may determine a similarity level between a context and preference of a user of the electronic device 200 and a context and preference of a plurality of users, set a rank of the plurality of users based on the determined similarity level, and determine at least one user who holds the highest rank among the plurality of users.

The controller 220 controls the communication device 210 to receive an electronic device setting from at least one user who is determined to have a high similarity level. In this case, the electronic device setting may include at least one among a user interface setting, an electronic device environment setting, an application program setting, and an icon of at least one application software.

The controller 220 may perform a security check for an electronic device setting of at least one user who has a high similarity level, and when the security check is performed, apply an electronic device setting of at least one user who has a high similarity level to the electronic device 200.

By receiving a recommendation of an electronic device setting from a plurality of users who have user information similar to the user information of a user, a user may perform an electronic device environment setting without manual manipulation.

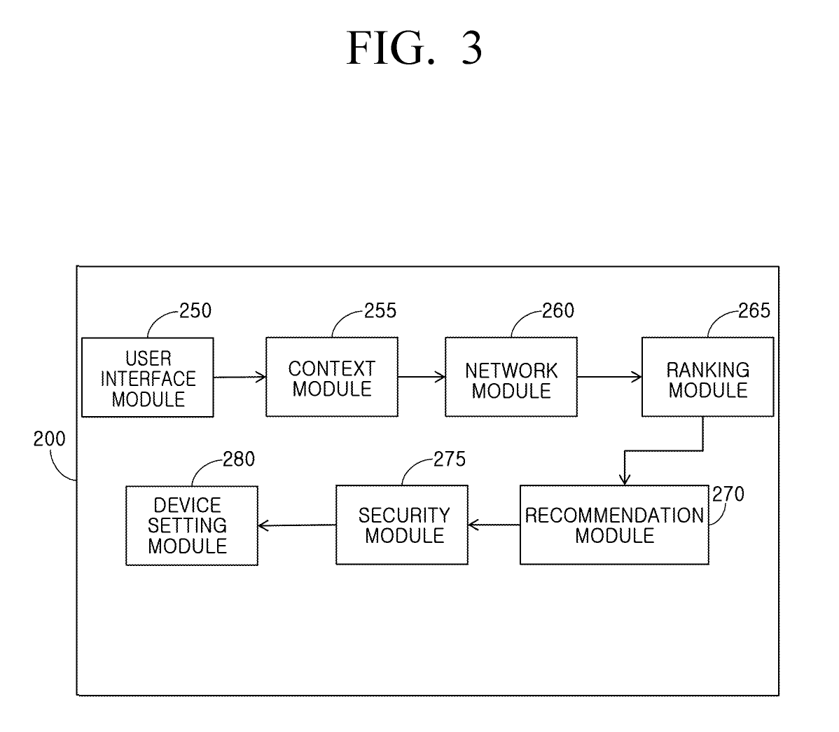

FIG. 3 is a block diagram illustrating a module which is included in an electronic device in accordance with an exemplary embodiment. As illustrated in FIG. 3, the electronic device 200 includes a user interface module 250, a context module 255, a network module 260, a ranking module 265, a recommendation module 270, a security module 275 and a device setting module 280. Meanwhile, in accordance with an exemplary embodiment, the modules 250-280 may operate by the controller 220. The modules 250-280 may be implemented as hardware.

The user interface module 250 enables a user of an electronic device to perform at least one user interaction of the electronic device. A user interaction may include, but is not limited to, an icon, a toolbar, at least one menu bar, and a plurality of user interface components which are used by a user, etc.

A user profile module is used to store profile information of a user of an electronic device. Profile information may include, but is not limited to, a browsing history, professional information, a frequently used software (e.g., a game application, etc.) of a user and a plurality of commercial activities conducted by a user. Profile information of a user of the electronic device 200 may be fixed, or may be fluid. In addition, the user profile module may maintain individual profile information based on each context of a user. The user interface module 250 may use profile information of a user in order to determine a user interface parameter, at least one application program, and at least one application software which is frequently used by a user.

The context module 255 is used to determine a context of a user of an electronic device in real time. A context may include, but is not limited to, location, time, an environment of a user, weather, a time zone, etc. In addition, the context module 255 includes a sensor module including a plurality of sensors. The sensor may include, but is not limited to, a GPS, an optical sensor, and a noise sensor, etc. The context module 255 may maintain location information, time, a user environment, etc. transferred by the sensor module. The user context which was determined by the context module 255 may determine a user interface parameter, an application program, and an application software which are used by a user in various contexts.

In an exemplary embodiment, a GPS which is included in the context module 255 is used to identify a location of a user of an electronic device. In addition, based on the location, a user context is determined. In addition, based on the determined context, a user interface parameter, an application program or an application software which is frequently used by a user is determined, and a corresponding electronic device setting may be provided to a user.

In another exemplary embodiment, an optical sensor which is included in the context module 255 is used to determine an atmosphere of a light associated with a user of an electronic device. In addition, the determined atmosphere of the light may be used to provide a corresponding electronic device setting (e.g., brightness adjustment of a display screen of the electronic device 200.)

In addition, the context module 255 may be used to maintain at least one activity which is performed by a user on a network site. The at least one activity is used to determine a plurality of users who have a preference or preferences similar to a preference or preferences of the user.

The network module 260 is used to call network information of a user from at least one network site including a social network such as Facebook and Orkut, etc. Network information may include, but not limited to, at least one activity which is associated with a user and a content which is posted by a user, etc.

The network module 260 obtains network information in order to identify a plurality of other users who are included in a social network of a user. In addition, the network module 260 identifies a plurality of users who exist in various networks of a user, such as a social network. The plurality of users identified by the network module 260 may have preferences which are similar to preferences of a user. In addition, the plurality of users identified by the network module 260 may have a context which is similar to a context of a user. In addition, the network module may operate to integrate a plurality of users who exist in various networks of a user.

The ranking module 265 may assign a rank to a plurality of users based on a similarity level between preferences of a user of an electronic device and preferences of a plurality of users. In addition, the ranking module 265 may assign a rank to a plurality of users based on a similarity level between a context of a user of an electronic device and a context of a plurality of users. In addition, based on a similarity level between a user of the electronic device 200 and a second set of users, the ranking module 265 may select the second set of users which includes at least one user from a plurality of users. A similarity level refers to a degree of similarity between preferences of a user of the electronic device 200 and preferences of the second set of users. In addition, the similarity level refers to a degree of similarity between a context of a user of the electronic device 200 and a context of the second set of users. The ranking module 265 may select a set of users from a plurality of users based on a similarity level between a user of the electronic device 200 and a set of other users.

The recommendation module 270 may recommend at least one electronic device setting which corresponds to the second set of users to a user of the electronic device 200. The recommendation module 270 transfers an electronic device setting of the second set of users to a user of the electronic device 200 before recommending an electronic device setting. The electronic device setting of the second set of users enables a user to easily access an environment setting of the electronic device 200 such as a user interface parameter, an application program, an environment setting of the electronic device 200, and an application software. The recommendation module 270 recommends an electronic device setting of the second set of users so that a user is able to easily access a user interface parameter, an application program, an environment setting of the electronic device 200 and an application software based on a context and a preference of a user of the electronic device 200. For example, an electronic device setting which was recommended by the recommendation module 270 creates a shortcut icon regarding at least one software application on a desktop of a user. In addition, the recommendation module 270 may provide the device setting module 280 with an electronic device setting of the second set of users.

The security module 275 may perform a security check operation for an electronic device setting of the second set of users who were recommended by the recommendation module 270 for security. The security module 275, in order to carry out the security check, may apply various security methods such as a sandbox and encoding.

The device setting module 280 operates so as to maintain an electronic device setting of a user of the electronic device 200. The device setting module 280 may apply an electronic device setting which was recommended by the recommendation module 280 in order to maintain an electronic device setting such as a user interface parameter, an application program, an environment setting of the electronic device 200, and an application software based on a user context and a user preference so that a user is able to easily access the device setting. Accordingly, the device setting module 280 may avoid an inconvenience of manually performing an environment setting of the electronic device 200 in order to obtain a necessary electronic device setting.

The electronic device 200 may include a communication interface for communication of a plurality of modules.

In accordance with another exemplary embodiment, a module illustrated in FIG. 3 may be uploaded to a server which is included in a cloud network 110.

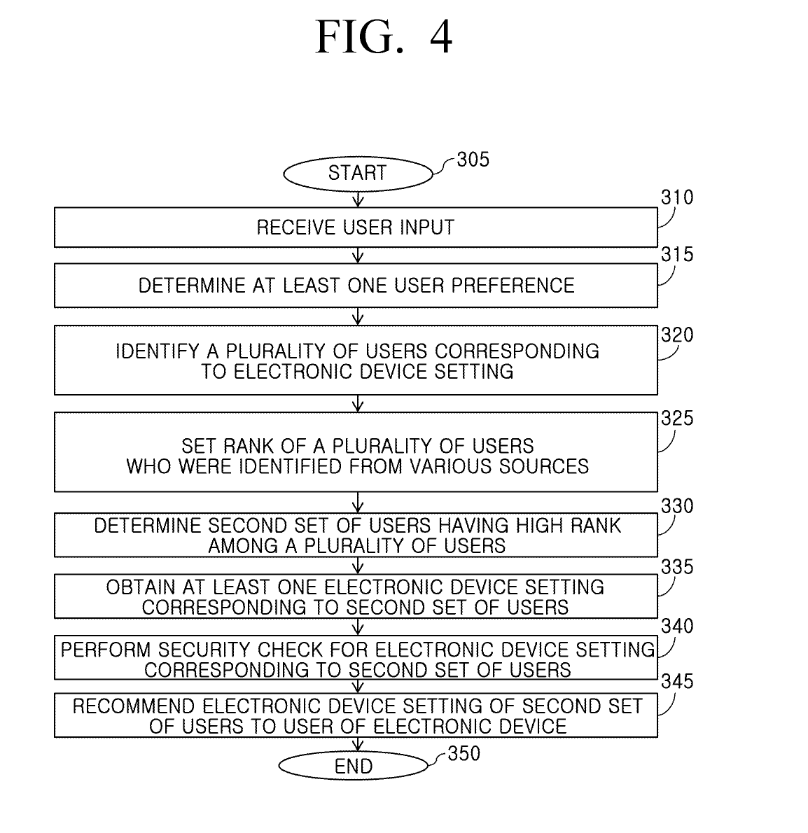

A method of obtaining a device management configuration based on distributed user experience is explained in detail in conjunction with FIG. 4.

FIG. 4 is a flowchart illustrating a method of obtaining a device management configuration based on distributed user experience, in accordance with an exemplary embodiment.

The method starts at operation 305. At operation 310 an input is received from a user, for example, a first user. The input includes activation of a recommendation mode, by a user, for obtaining recommendations for one or more device settings. The activation can be performed using one or more input devices, for example, menu buttons, keyboard, mouse, pointers and the like. The activation of the recommendation mode for obtaining the recommendations for the device settings, enables the user to create a shortcut for one or more user interface (UI) parameters, software applications, device configurations and various other device applications such that they are instantly accessible by the user.

At step 315 one or more preferences of the user is determined. The preferences are determined based on a context of the user. Examples of the context include, but are not limited to, location, time, environment of the user, weather, part of the day and the like. A context module, for example, the context module 210 is used to determine the context of the user. A user profile is used for storing the preferences based on the context.

In one example, the context of the user can include an official environment. The context module, using sensors, determines that the user is located at the office. Hence multiple work-related applications, for example, but not limited to, MS-Word, an invoicing software, preferred by the user while the user is located at the office, may be included in the user profile. Similarly, in another example, the context may determine that the user is located at home. Therefore, one or more home-related applications, for example, but not limited to, media players, gaming software or user interface (UI) parameters preferred by the user while the user is located at home are included in another user profile. Hence, individual user profiles may be maintained for storing preferences based on each context of the user.

At operation 320, multiple users with corresponding device settings are identified. The multiple users are identified from multiple sources. Examples of the multiple sources include, but are not limited to, a network, for example, a social network or a professional network of the user. The corresponding device settings are obtained based on preferences associated with each of the multiple users. The corresponding device settings are also obtained based on a context associated with each of the multiple users. The corresponding device settings, in one example, is used for creating a shortcut for one or more user interface (UI) parameters, software applications, device configurations and various other device applications such that they are instantly accessible by each of the multiple users.

At operation 325, the multiple users identified from the multiple sources are ranked based on a similarity level existing between the preferences associated with each of the multiple users and the preferences of the user. Further, the multiple users are also ranked based on a similarity level existing between the contexts associated with each of the multiple users and the context of the user. A ranking module, for example, the ranking module 220 is used to rank the multiple users.

At operation 330, one or more users, for example, a second set of users, of the multiple users having a highest rank is determined. The second set of users may be determined statically or dynamically. Various machine learning techniques can be used for determining the second set of users dynamically. Further, the highest rank is provided in response to possessing an increased similarity level between the context associated with the second set of users and the context of the first user. Further, the highest rank is also provided for possessing an increased similarity level between the preferences associated with the second set of users and the preferences of the first user. One or more comparing algorithms can be used for determining the similarity levels. Further, more than one user, having the highest rank, can also be determined.

At operation 335, one or more device settings corresponding to the second set of users having the highest rank is fetched. The device settings corresponding to the second set of users includes, for example, but not limited to, a user interface setting, a device configuration setting, an application program setting and a shortcut for one or more application software, based on various preferences and contexts of the second set of users.

At operation 340, a security check is performed for the device settings, corresponding to the second set of users, fetched at operation 335. The security check is performed to prevent security threats while recommending the device settings of the second set of users to the first user. Various algorithms can be used for performing the security check. A security module, for example, the security module 230 is used for performing the security check. Further, if the security check for the device settings of the second set of users fails, then the device settings is restrained from being recommended to the first user.

At operation 345, the device settings of the second set of users are recommended to the first user since the contexts and preferences of the second set of users is similar to the contexts and preferences of the first user. Recommending the device settings prevents the first user from performing manual configuration to obtain the device settings. Further, recommending the device settings also enables the first user to obtain the device settings instantly and enables the user to readily access and execute one or more applications. The method stops at operation 350.

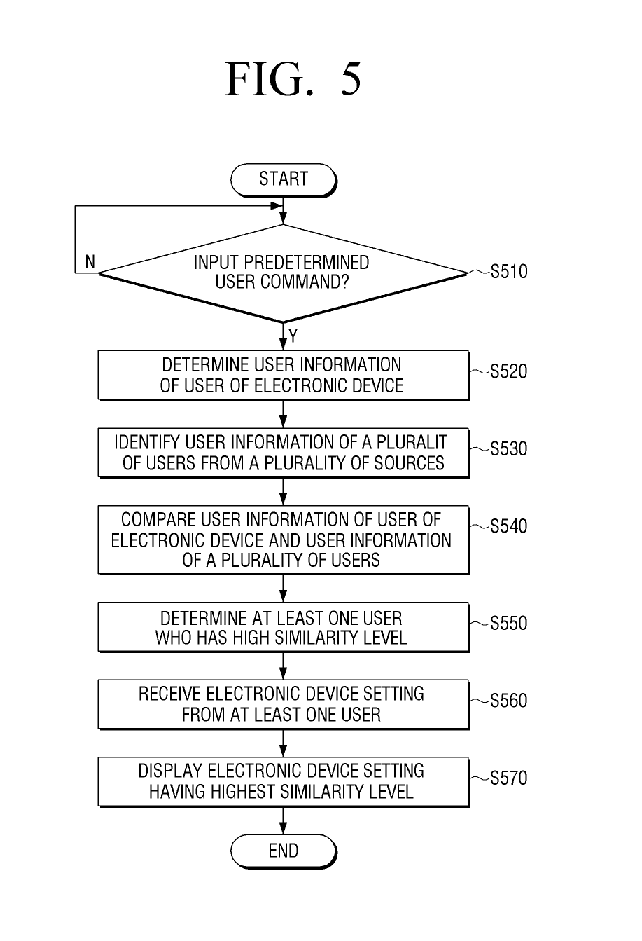

Hereinafter, referring to FIG. 5, in accordance with another exemplary embodiment, a method for managing an electronic device setting of the electronic device 200 will be described.

The electronic device 200 determines whether a predetermined user command is inputted (operation S510). In this case, the predetermined user command may be a command to select a predetermined icon included in a menu which is displayed in the electronic device 200.

When the predetermined user command is inputted (operation S510), the electronic device 200 determines user information of a user of an electronic device (operation S520). In this case, the user information may include at least one of a user context and a user preference.

In addition, the electronic device 200 identifies user information of a plurality of users from a plurality of sources (operation S530).

In addition, the electronic device 200 compares user information of a user of an electronic device and user information of a plurality of users (operation S540), and determines at least one user who has a high similarity level (operation S550). To be specific, the electronic device 200 determines a similarity level between at least one context and at least one preference of a user of the electronic device 200 and at least one context and at least one preference of a plurality of users, and based on the determined similarity level, and sets a rank of the plurality of users. In addition, the electronic device 200 may determine at least one user who has the highest similarity level among the plurality of users. Particularly, the electronic device 200 may determine a user context by using at least one of a GPS and an optical sensor.

In addition, the electronic device 200 receives an electronic device setting from at least one user who is determined to have a high similarity level (operation S560). In this case, the received electronic device setting may include at least one of a user interface setting, an electronic device environment setting, an application program setting, and an icon of at least one application software.

In addition, the electronic device 200 displays an electronic device setting which has a highest similarity level (operation S570). In this case, the electronic device 200 may display information regarding an electronic device setting, and may display a display screen by applying an electronic device setting.

In accordance with the aforementioned various exemplary embodiments, by receiving a recommendation of an electronic device setting from a plurality of users who have user information similar to a user of an electronic device, a user may perform an electronic device environment setting without manual manipulation.

As given above, desirable exemplary embodiments were described and explained, but the exemplary embodiments are not limited to the aforementioned particular exemplary embodiments, could be variously modified and achieved by a person of ordinary skill in the art to which the exemplary embodiments pertain without deviating from the substance of the exemplary embodiments which are claimed in the claims, and such modification should not be understood separately from the technical concept or prospect of the exemplary embodiments.

What is claimed is:

1. A method of managing an electronic device setting, the method comprising:
determining user information of a first user of the electronic device;
identifying user information of a plurality of second users from a plurality of external sources;
comparing the user information of the first user of the electronic device and the user information of the plurality of second users, and determining at least one user of the plurality of second users who has a high similarity level to the first user of the electronic device based on a result of the comparing;
receiving electronic device settings from the at least one user of the plurality of second users who has the high similarity level; and
displaying an electronic device setting which is received from a user of the plurality of second users who has a highest similarity level among the received electronic device settings.

2. The method as claimed in claim 1, wherein the user information comprises at least one of a user context and a user preference.

3. The method as claimed in claim 2, wherein the determining comprises determining a similarity level between a user context and user preference of the first user of the electronic device and a user context and user preference of the plurality of second users;
setting a rank of the plurality of second users based on the determined similarity level; and
determining at least one user of the plurality of second users who holds a highest rank.

4. The method as claimed in claim 2, wherein the determining comprises determining a user context based on at least one of a Global Positioning System (GPS) and an optical sensor.

5. The method as claimed in claim 1 comprising:
performing a security check for an electronic device setting of the at least one user of the plurality of second users who has the highest similarity level; and
when the security check is performed, applying the electronic device setting of the at least one user of the plurality of second users who has the highest similarity level to the electronic device of the first user.

6. The method as claimed in claim 1, wherein the electronic device setting comprises at least one of a user interface setting, an electronic device environment setting, an application program setting, and an icon of at least one application software.

7. The method as claimed in claim 1, further comprising:
displaying user information of the plurality of second users.

8. An electronic device comprising:
a communication device configured to perform communication with at least one external device;
an input configured to receive a user command;
a controller configured to determine user information of a first user of the electronic device when a predetermined user command is inputted through the input, identify user information of a plurality of second users received from a plurality of sources through the communication device, compare the user information of the first user of the electronic device and the user information of the plurality of second users, and determine at least one user of the plurality of second users who has a high similarity level to the first user of the electronic device based on a result of the comparing; and control the communication device to receive an electronic device setting from the at least one user of the plurality of second users who has the high similarity level, and
a display configured to display an electronic device setting which was received from a user of the plurality of second users who has a highest similarity level among the received electronic device settings.

9. The device as claimed in claim 8, wherein the user information comprises at least one of a user context and a user preference.

10. The device as claimed in claim 9, wherein the controller is configured to determine a similarity level between the user context and the user preference of the first user of the electronic device, and the user context and the user preference of the plurality of second users, set a rank of the plurality of second users based on the determined similarity level, and determine at least one user of the plurality of second users who holds a highest rank among the plurality of second users.

11. The device as claimed in claim 9, wherein the determining comprises determining a user context by using at least one of a Global Positioning System (GPS) and an optical sensor.

12. The device as claimed in claim 8, wherein the controller performs a security check for an electronic device setting of the at least one user of the plurality of second users who has the high similarity level, and when the security check is performed, applies the electronic device setting of the at least one user of the plurality of second users who has a high similarity level to the electronic device of the first user.

13. The device as claimed in claim 8, wherein the electronic device setting comprises at least one of a user interface setting, an electronic device environment setting, an application program setting, and an icon of at least one application software.

14. The device as claimed in claim 8, wherein the display is configured to display user information of the plurality of second users.

15. A method of managing settings of an electronic device, the method comprising:
determining user information of a user of the electronic device;
determining user information of a plurality of external users;
comparing the user information of the user of the electronic device and the user information of the plurality of external users;
determining a set of users of the plurality of external users who have a high similarity level to the user of the electronic device,
determining a user in the set of users who has a highest similarity level, and
displaying and recommending an electronic device setting received from the user who has the highest similarity level.

16. The method of claim 15, wherein the electronic device setting comprises at least one of a user interface setting, an electronic device environment setting, an application program setting, and an icon of at least one application software.

17. The method of claim 15, wherein the similarity level is between at least one context and at least one preference of the user of the electronic device, and at least one content and at least one preference of the plurality of external users.
